(19) United States
(12) Patent Application Publication
(10) Pub. No.: US 2007/0071661 A1
(43) Pub. Date: Mar. 29, 2007

(54) Reformer for fuel cell

(75) Inventors: Ro Woon Lee, Seoul (KR); Sang Jin Kim, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/525,920

(22) Filed: Sep. 25, 2006

(30) Foreign Application Priority Data
Sep. 29, 2005 (KR) 10-2005-0091385

(51) Int. Cl. B01J 19/00

(52) U.S. Cl. 422/198

(57) ABSTRACT

The invention relates to a reformer with superior heat characteristics for supplying hydrogen gas as fuel to a fuel cell of a fuel cell system. The reformer includes a base having an evaporating part, a reforming part and flow paths each formed in the evaporating part and the reforming part. The reformer also includes heaters each attached on the base corresponding to the positions of the evaporating part and the reforming section. The reformer further includes a catalyst disposed in the reforming section of the base and a porous part integrally formed in a portion of the base extending from the evaporating part to the heater. The reformer has the porous part including nano-pores to increase heat absorption, preventing heat losses. This allows increased heat efficiency and sufficient heat supply with minimal energy, thereby enhancing operational characteristics of the reformer.

### CLAIM OF PRIORITY

This application claims the benefit of Korean Patent Application No. 2005-91385 filed on Sep. 29, 2005, in the Korean Intellectual Property Office, the disclosure of which is incorporated herein by reference.

### BACKGROUND OF THE INVENTION

1. Field of the Invention

The present invention relates to a reformer for supplying hydrogen gas as a fuel to a fuel cell of a fuel cell system. More particularly, the invention relates to a reformer with superior heat characteristics, which has a porous part with nano-pores formed in a portion of a base corresponding to an evaporating part to prevent heat losses with increased heat absorption capacity of the porous part, thereby increasing heat efficiency of the evaporating part and allowing sufficient heat supply with a small amount of energy.

2. Description of the Related Art

In recent years, as energy depletion and environmental pollution have become important issues, attention and development have been focused on less polluting fuel cells. Such a fuel cell is advantageous in that it directly oxidizes a fuel such as hydrogen to generate electricity, thus hardly generating noise and pollutants during the operation.

A fuel cell is defined as one that converts the chemical energy to electrical energy to produce direct current. It is different from a conventional battery in that fuel and air is supplied from an outside source to produce electricity continuously.

That is, the basic concept of the fuel cell is use of electrons generated from the reaction between hydrogen and oxygen. More specifically, with hydrogen passing through an anode and oxygen through a cathode, hydrogen reacts with oxygen electrochemically to produce water and generate current.

In the fuel cell, the electrons pass through an electrolyte membrane to generate direct current, thus generating heat. The direct current is used to power a DC electromotor or converted to alternating current by an inverter to be used. The heat generated from the fuel cell can be used for producing steam for reforming or for heating and air conditioning. Thus, the fuel cell is superior to a conventional lithium ion battery in the aspect of recycling the heat.

The fuel cell uses hydrogen which is generated from a process called reforming through which pure hydrogen and hydrocarbon like methanol are reformed into hydrogen. Such an apparatus for reforming methanol, etc. into hydrogen, which is the fuel for the fuel cell, is provided in this invention.

In addition, with higher-purity oxygen supplied to the fuel cell, the fuel cell operates with higher efficiency. However, as there are many problems with the storage of oxygen in practice, air containing much oxygen is used, and the reactions occurring in the fuel cell are as follows.
Anode: H₂—→2H++2e−
Cathode: O₂+2H++2e−—→H₂O
Net: H₂+O₂—→H₂O+current+heat

Here, interposed between the anode and the cathode, the electrolyte (membrane) which is a medium for migration of electrons, enables a hydrogen ions to migrate from one electrode to the other. In order to minimize resistance to migration of the ions, it is preferable that such an electrolyte (membrane) is provided as thinly as possible but not to such a degree that the electrodes (anode/cathode) contact each other.

The fuel cells explained above can be classified into various types, which do not differ in the basic operational principles but differ in terms of types of fuels, operating temperatures, types of catalysts and electrolytes.

For example, the fuel cells can be differentiated into Phosphoric Acid Fuel Cells (PAFCs), Alkaline Fuel Cells (AFCs), Proton Exchange Membrane Fuel Cells (PEMFCs), Molten Carbonate Fuel Cells (MCFCs), Solid Oxide Fuel Cells (SOFCs), Direct methanol Fuel Cells (DMFCs), and the like (hereinafter, each referred to by its abbreviation).

Recently, with increased use of mobile communication terminals, notebook computers and the like (hereinafter, referred to as ‘portable apparatuses’), researches have been focused on fuel cells for supplying power to these apparatuses.

For the portable apparatuses such as the notebook computers or mobile phones, the major issues have been improvement of functions and services, and in particular, miniaturization. Thus, the main issue for the fuel cells has been miniaturization as well.

The capacities of the secondary batteries such as the lithium ion batteries have been improved since the time when they were mounted in the earlier portable apparatuses. However, recent researches have been focused on mounting fuel cells that are miniaturized and with higher capacity in the apparatuses.

Among the above listed types of fuel cells, DMFC and PEMFC (PEFC) are the most researched types practicable for micro fuel cells mounted in the portable apparatuses.

The DMFC and PEMFC differ in that they use methanol and hydrogen, respectively, for fuel, thereby having different capacities and fuel supply systems with comparable merits and demerits.

However, with significantly low output density, the DMFC is depreciated in its practical value although it is much researched for supplying power to the portable apparatuses.

On the other hand, using hydrogen, the PEMFC (PEFC) requires a reformer which reforms fuel such as methanol into hydrogen gas and supply to a fuel cell (cell). Thus, except for the increased size due to the reformer, it is advantageous for supplying power to the portable apparatuses with respect to output density.

Therefore, miniaturization of the reformer and reduction of the mounting area therefor in the apparatus have been the prerequisites for the fuel cells of the portable apparatuses, and in particular, the PEMFC.

FIGS. 1 and 2 schematically illustrate a reformer used in a calculator, among the portable apparatuses, according to the prior art.

As shown in FIG. 1, there have been known a fuel cell system 100 including a fuel cell 110 and a reformer 120 for supplying reformed hydrogen to the fuel cell 110.

As shown in FIGS. 1 and 2, although not separately illustrated in a diagram or with symbols, the conventional reformer 120 for a fuel cell system is composed of cells each with narrow flow paths (channels) formed thereon stacked in multiple layers, thus generating an insignificant amount of reformed hydrogen. In addition, although the overall size is reduced, many problems are incurred in the processes such as forming the flow paths in the multiple layers of cells.

For example, in the conventional reformer 120, narrow flow paths are formed in a micro-unit on a substrate (cell) made of silicon (Si), glass or stainless steel, and a catalyst is coated on the narrow flow paths to generate reformed hydrogen gas.

In addition, the conventional reformer 120 is formed with silicon wafers stacked to integrate a catalytic combustor, an evaporator, a hydrogen generator, a CO remover, a sensor and a heater therein for reforming (generating) hydrogen.

In addition, the conventional reformer 120 has a complex structure (system) in which a thin-film heater made of Au is provided inside the reformer and a high temperature treatment is executed in a portion of high-temperature of at least 280° C. With the internal parts of the reformer having different temperatures, the fuel is passed through the flow path (pass line) formed on the multi-layered substrate to execute the processes including ‘removing CO’, ‘evaporating reformed fuel’ and ‘evaporating combusted fuel’.

However, it is difficult to use the above described reformer for practical purposes with varying temperatures according to the heights of different parts of the reformer, difficulty of insulating the high temperature, and the insignificant amount of hydrogen output.

In the meantime, a reformer composed of the multiple layers of cells and the flow paths, similar to the reformer shown in FIG. 1 is disclosed in U.S. Patent Application No. 2004/00191591, which however shares the same problems described above.

There is suggested another reformer having an evaporator section and a reformer section formed in a silicon substrate in Japanese Patent Application Publication No. 2004-006265.

In the above reformer, heating wires are installed as a heater on the substrate to gasify and thereby reform methanol into hydrogen.

This reformer however has only the heating wires provided in the cell or on the substrate without including means to effectively deter the heat from being transferred to the outside.

If the losses of heat occur, not only the heat characteristics of the reformer are degraded but also more thermal energy is required to evaporate the fuel, thus resulting in other operational problems of the reformer.

Such degradation of the heat characteristics negatively affects the two major operational characteristics of the reformer, i.e., evaporating and reforming functions.

### SUMMARY OF THE INVENTION

The present invention has been made to solve the foregoing problems of the prior art and therefore an object of certain embodiments of the present invention is to provide a reformer for a fuel cell system with superior heat characteristics having a porous part in a part of the base corresponding to an evaporating part to increase heat absorption, preventing losses of heat, thereby increasing heat efficiency of the evaporating part while supplying sufficient heat to the evaporating part with minimal energy.

According to an aspect of the invention for realizing the object, there is provided a reformer for a fuel cell having superior heat characteristics including: a base having an evaporating part, and a reforming part disposed separately from the evaporating part, and flow paths each formed in the evaporating part and the reforming part; a heater attached on the base corresponding to the positions of the evaporating part and the reforming section; a catalyst disposed in the reforming section of the base; and a first porous part integrally formed in a portion of the base extending from the evaporating part to the heater to increase heat efficiency.

At this time, the base may be a wafer.

In addition, the heater may be a heating wire formed on the base.

In addition, the catalyst may include a first catalyst layer made of CuO or ZnO, which reforms a gasified fuel into a hydrogen gas at the evaporating part.

At this time, the catalyst may further include a second catalyst made of Al or Al₂O₃ provided underneath the first catalyst as a supporting layer for the first catalyst to maintain a stable catalyst function.

Here, it is preferable that the second catalyst is formed on a surface of the flow path of the reforming part of the base and the first catalyst is formed on the second catalyst layer.

In addition, the first porous part formed in the evaporating part of the base includes nano-pores integrally formed in the base by anode corrosion.

At this time, it is preferable that the reformer further includes a second porous part formed underneath the reforming part to increase a catalyst area.

Here, the second porous part includes nano-pores integrally formed in the base by anode corrosion.

Here, the first and second porous parts have insulation layers formed underneath with the heater disposed between the insulation layers.

In addition, the reformer further includes a cover member covering upper and lower parts of the base, the cover member having a fuel inlet and a hydrogen outlet.

In addition, the reformer may further include a means for removing CO to emit a high-purity hydrogen gas, and the CO removing means is formed on a portion of an inner surface of the cover member, corresponding to the position of an emission path at which reformed hydrogen is emitted.

Here, the CO removing means may be made of one selected from Pt and Pd.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an overall perspective view illustrating a fuel cell and a reformer according to the prior art;

FIG. 2 is a schematic perspective view illustrating the reformer according to the prior art;

FIG. 3 is a structural view illustrating a reformer for a fuel cell with superior heat characteristics according to the present invention;

FIG. 4 illustrates the reformer of FIG. 3 according to the present invention in which (a) is a plan view of flow paths of a reforming part and an evaporating part and (b) is a bottom surface thereof including heating wires for heating the reforming part and the evaporating part;

FIGS. 5a to 5i are views illustrating manufacturing steps of the reformer for a fuel cell with superior heat characteristics according to the present invention;

FIG. 6 is a structural view illustrating a reformer according to another embodiment of the present invention;

FIG. 7a is a schematic view illustrating formation of a porous part in a base of the reformer by anode corrosion according to the present invention; and

FIG. 7b is a picture showing the porous part of the base of the reformer according to the present invention.

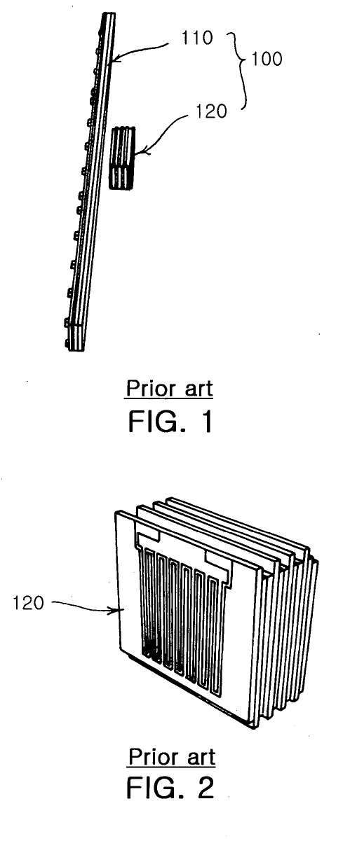

### DETAILED DESCRIPTION OF THE PREFERRED EMBODIMENT

Preferred embodiments of the present invention will now be described in detail with reference to the accompanying drawings.

The reformer 1 (in particular, micro reformer) for a fuel cell according to certain embodiments of the present invention is aimed to mitigate the difficulty of maintaining the heat characteristics of the conventional reformer and increase a catalyst area to increase catalytic capability. Thus, ultimately, the reformer 1 of the invention is aimed to generate high-purity hydrogen gas with removal of CO, thereby enhancing the output density of the fuel cell supplied with the hydrogen gas.

The reformer for a fuel cell according to the present invention is one used in the PEMFC which mainly uses hydrogen (gas) as fuel.

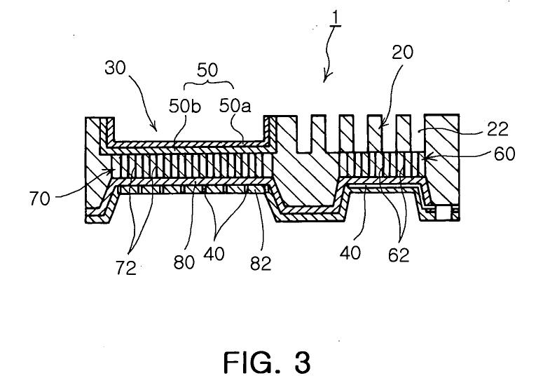

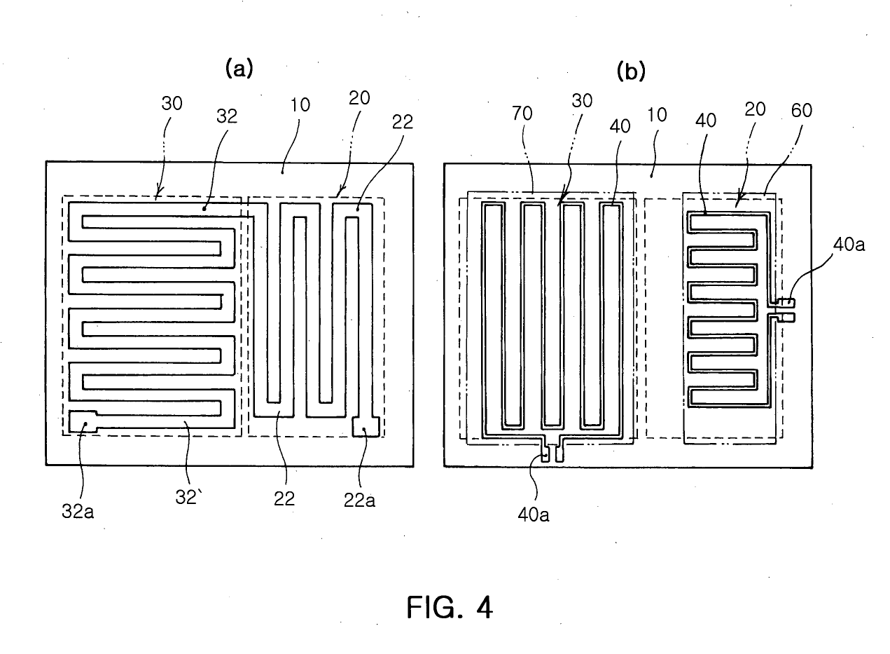

FIGS. 3 and 4 illustrate the reformer 1 for a fuel cell with superior heat characteristics according to the present invention.

As shown in FIGS. 3 and 4, the reformer 1 according to the present invention includes a base 10 having an evaporating part 20, a reforming part 30 separately disposed from the evaporating part 20 and flow paths 22 and 32 each formed in the evaporating part 20 and the reforming part 30. The reformer also includes heaters 40 attached on the base 10 by deposition, etc. corresponding to the positions of the evaporating part 20 and the reforming part 30, a catalyst 50 disposed in the reforming part of the base, and a first porous part 60 (for example, porous silicon part) integrally formed in a portion of the base 10 corresponding to the position of the evaporating part.

In the reformer 1 with the above configuration, methanol supplied from the evaporating part 20 is heated and gasified, and the heated methanol gas continuously moves from the evaporating part 20 to the reforming part 30 through the flow paths 22 and 32.

As shown in FIG. 4(a), the flow path 22 of the evaporating part 20 and the flow path 32 of the reforming part 30 are connected to each other and formed in opposite directions by etching the base 10, etc.

The flow path 22 of the evaporating part 20 has a fuel inlet 22a formed at an end thereof and the flow path 32 of the reforming part 30 has a hydrogen (gas) outlet 32a formed at an end thereof.

The methanol gas is reformed into hydrogen at high temperature by a catalyst 50 (FIG. 3), and the reformed hydrogen gas is supplied to a fuel cell (not shown) from the reformer and used as fuel for the fuel cell.

In the reformer 1 of the present invention, the first porous part 60 is integrally provided in a portion of the base 10 corresponding to the position of the heater.

Therefore, in the reformer 1 of the present invention, the heat generated from the heater 40 is mostly absorbed by the first porous part 60 before being transferred through the base 10 to the outside, thereby increasing heat preserving capability.

As a result, in the reformer 1 according to the present invention, the first porous part 60 provided at the portion of the evaporation part of the base 10 contributes to increase heat efficiency. Thus, even with a minimal amount of thermal energy and its reduced size, the reformer has high efficiency, having heat characteristics at least equivalent to those of a reformer without the porous parts.

As shown in FIG. 3, the base 10 is a wafer, i.e., a silicon substrate.

Therefore, the reformer according to the present invention can be manufactured in a plurality through a wafer process, enabling mass production.

At this time, the heaters 40 can be composed of heating wires, which can be formed by depositing highly conductive Pt/Ti, etc. on a wafer.

The heaters 40 may have configurations in opposite directions as shown in FIG. 3 and FIG. 4(b).

With the heater 40 provided also at the side of the reforming part 30 of the base 10, the gasified methanol is prevented from being cooled down and maintains its gaseous state while passing through the path, thereby facilitating the reforming process of the hydrogen through catalytic reaction.

Reference numerals 40a and 40b in FIG. 4(b) denote external connection terminals of the reformer.

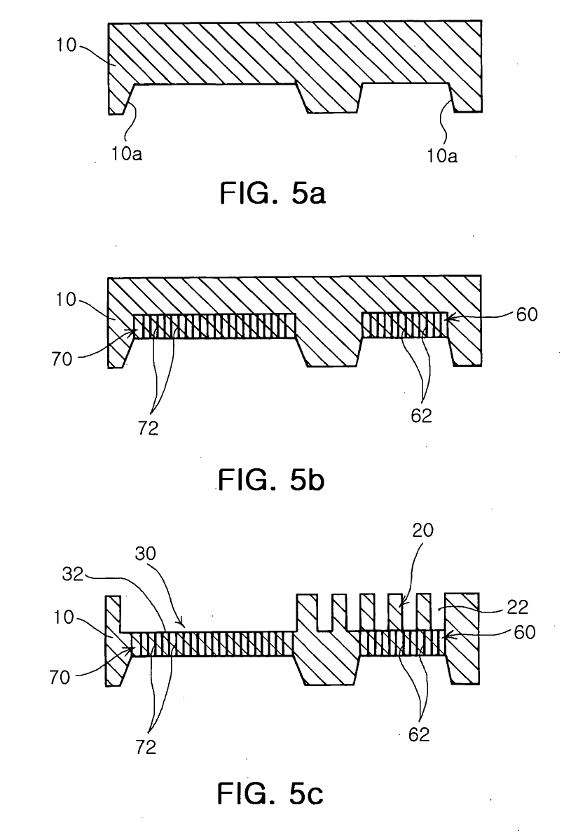

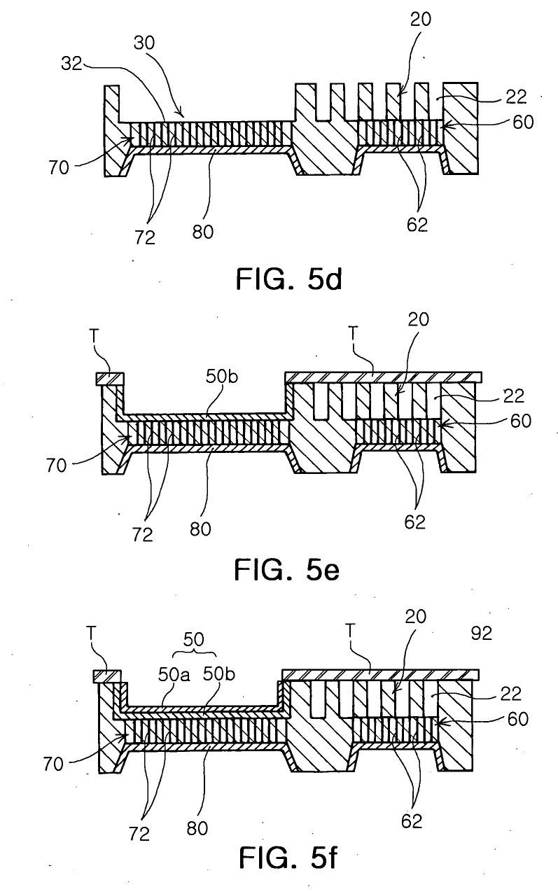

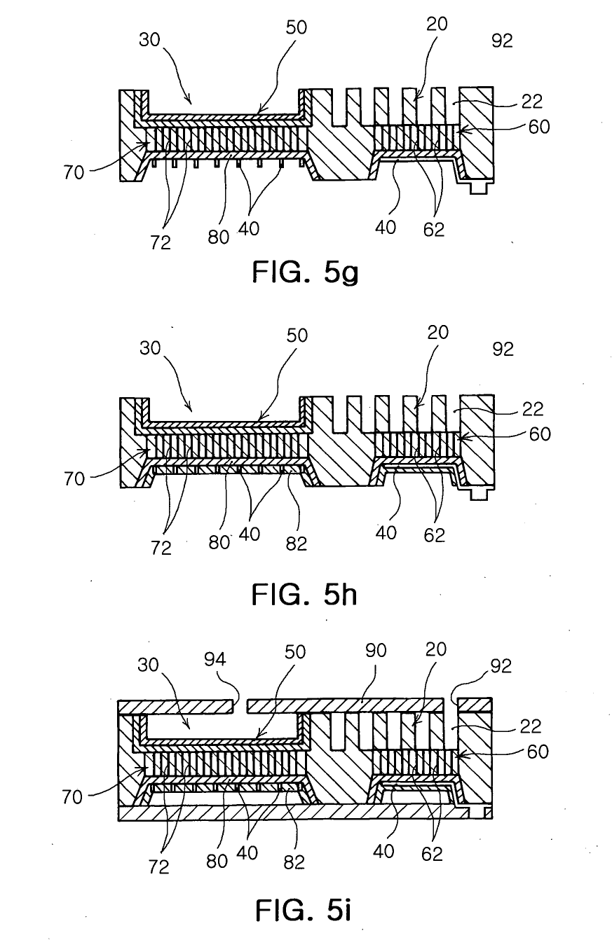

In the meantime, as shown in FIG. 3, the catalyst 50 may be composed of a first catalyst 50a made of CuO and ZnO for reforming methanol into hydrogen and a second catalyst 50b made of Al or Al₂O₃ serving as a protective layer to maintain a stable and prolonged catalyst function of the first catalyst 50a, as will be explained in detail with reference to FIGS. 5a to 5i.

At this time, as shown in FIGS. 3 to 5i, it is preferable that the second catalyst 50b is coated on the surface of the flow path 32 of the reforming part 30 of the base 10 and the first catalyst 50a is coated on the second catalyst 50b.

In the meantime, as shown in FIGS. 3 and 4, a second porous part 70 can be additionally provided in a portion of the base 10 corresponding to the reforming part 30 in order to increase the catalyst area.

At this time, the first porous part 60 formed in the base 10 corresponding to the evaporating part includes nano-pores 62 integrally formed in the base, and the second porous part 70 also includes nano-pores 72 integrally formed in the base of silicon.

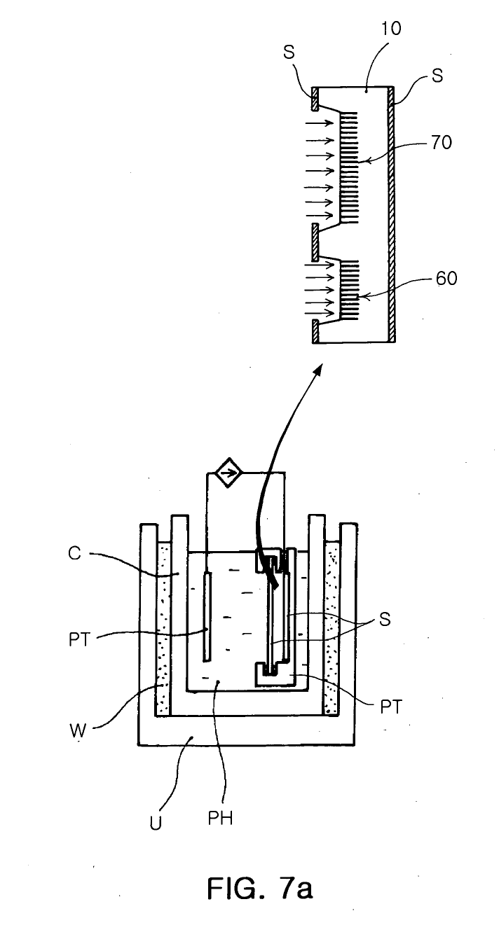

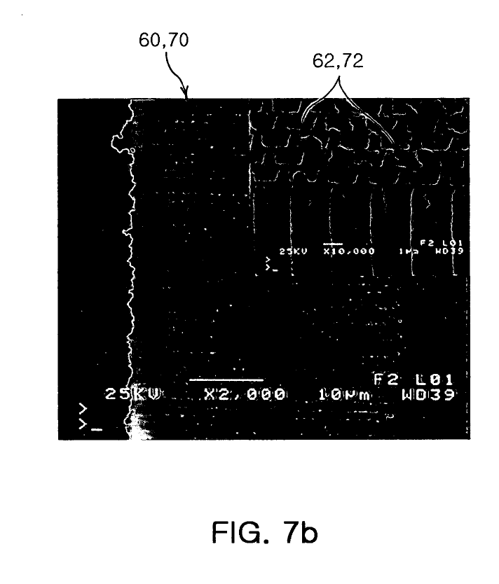

That is, as shown in FIG. 7b, the first porous part 60 of the sides of the evaporating part includes the ultra-fine pores, i.e., nano-pores formed therein, and the heat generated from the heater 40 of heating wires is internally absorbed and preserved in the nano-pores 62 of the first porous part 60, preventing losses of heat and thereby resulting in superior heat characteristics.

At the same time, the second porous part 70 of the reforming part 30 including the nano-pores serves to increase the coating area on which the aforedescribed catalyst 50 is coated, enhancing the catalytic reactivity of the methanol gas passing through the flow path, thereby ultimately improving reforming capability of the reformer.

The first and second porous part 60 and 70 can be integrally formed in the base 10, a silicon wafer, respectively at the sides of the evaporating part 20 and the reforming part 30, via anode corrosion.

For example, as shown in FIG. 7a, a cell C is housed in an ultrasound generator, heated by surrounding warm water W. And the base 10 is connected between catalyst metals (Pt) in fluorine solution mixed with pure water in the cell C. As electricity is applied between the catalyst metals (Pt), the fluorine solution collides with the base 10, thereby forming the porous parts 60 and 70 including the fine nano-pores 62 and 72 in the base 10.

At this time, as shown in FIG. 7a, excluding the portions where the porous parts are to be formed, the base 10 is covered with silicone S using a glue gun, etc. to prevent infiltration of the fluorine solution PH.

Thereby, as shown in FIG. 7b, porous parts 60 and 70 are formed in the desired portions of the base 10 via anode corrosion. The porous parts are formed to include the nano-pores 62 and 72 therein, which serve to preserve heat and increase the catalyst area, respectively, there by realizing the features of the present invention.

The first and second porous parts are simultaneously formed in the base, in practice.

As shown in FIG. 3, insulation layers 80 and 82 made of SiO₂ and Si3N₄ are formed adjacent to the first and second porous parts 60 and 70 on the side of the base 10 without the flow paths formed thereon. The heating wires of the heater 40 are deposited between the insulation layers 80 and 82.

At this time, the insulation layers 80 and 82 also serve a sealing function to prevent damage to the heating wires and prevent the nano-pores 62 and 72 of the porous parts of the evaporating part and the reforming part from being exposed.

FIGS. 5a to 5i illustrate manufacturing steps of the reformer according to the present invention.

That is, as shown in FIG. 5a, a side of the base 10, which is a silicon substrate or a wafer, is machined to form a recessed spaces 10a for mounting insulation layers and heaters therein, corresponding to each of the evaporating part and the reforming part, respectively, via wet etching.

Then, as shown in FIG. 5b, first and second porous parts 60 and 70 including nano-pores 62 and 72 are integrally formed in the recessed spaces 10a of the base 10, respectively, via anode corrosion illustrated in FIG. 7a.

Next, as shown in FIG. 5c, flow paths 22 and 32 are integrally formed in zigzag shapes in opposite directions, as shown in FIG. 4a, in the evaporation part and the reforming part via dry etching. Here, the flow paths 22 and 32 are formed adjacent to the porous parts.

Next, as shown in FIG. 5d, insulation layers 80 are formed underneath the porous parts 60 and 70.

Then as shown in FIGS. 5e and 5f, with the portions of the flow paths 22 and 32 taped T, and first catalyst 50a and second catalyst 50a are sequentially formed. In practice, the catalysts are formed via sputtering along the surface of the flow path 32 formed on the base.

Next, as shown in FIGS. 5g and 5h, the heaters 40 made of heating wires of Pt/Ti is deposited via sputtering on the insulation layer 80.

Then, as shown in FIGS. 5h and 5i, second insulation layers 82 are formed on the lowermost heating wires, and finally a cover member 90, for example a glass, having a fuel inlet 92, and an outlet 94 for emitting reformed hydrogen gas, is bonded to the base 10.

Thereby, the reformer 1 according to the present invention is completed.

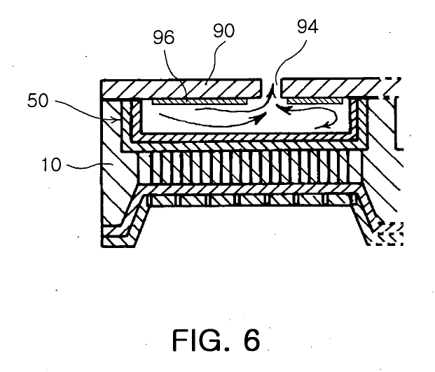

At this time, as shown in FIG. 6, a CO remover 96, for example, made of Pt and Pd can be coated on an inner surface of the cover member 90 to remove CO, thereby enabling emission of high-purity hydrogen.

That is, the CO remover 96 is deposited on a portion of the glass cover member 90 corresponding to an ending path 32′ connected to the hydrogen gas outlet 32a to remove CO contained in the reformed hydrogen gas.

Removing CO, which is the cause of low catalytic efficiency of the catalyst provided in the fuel cell, allows emission of high-purity hydrogen gas and ultimately improves the characteristics of the fuel cell.

According to the reformer of the present invention, the heat is preserved by nano-pores of the porous part formed in the portion corresponding to the evaporating part of the base made of a silicon substrate, and thus is prevented from being transferred to the outside and concentrated at the porous part. This allows sufficient heat supply with a small amount of energy and increased heat efficiency in the reformer.

In addition, the porous part is integrally formed also at the reforming part of the base to increase the catalyst area, thereby enhancing the catalytic capability which is the most important factor in the reformer.

Moreover, capillary action by which methanol fuel is absorbed in the nanopores of the porous parts, allows efficient absorption of fuel and evaporation of the reformer to enable sufficient gasification during heating, thereby improving reformability of fuel into hydrogen gas.

Therefore, the reformer according to the present invention is provided in an ultra-small size, requiring reduced supply of thermal energy, which is most ideal in terms of operational costs or thermal efficiency.

While the present invention has been shown and described in connection with the preferred embodiments, it will be apparent to those skilled in the art that modifications and variations can be made without departing from the spirit and scope of the invention as defined by the appended claims.

What is claimed is:

1. A reformer for a fuel cell having superior heat characteristics comprising:
a base having an evaporating part, and a reforming part disposed separately from the evaporating part, and flow paths each formed in the evaporating part and the reforming part;
heaters each attached on the base corresponding to the positions of the evaporating part and the reforming section;
a catalyst disposed in the reforming section of the base; and
a first porous part integrally formed in a portion of the base extending from the evaporating part to the heater to increase heat efficiency.

2. The reformer according to claim 1, wherein the base comprises a wafer.

3. The reformer according to claim 1, wherein the heater comprises a heating wire formed on the base.

4. The reformer according to claim 1, wherein the catalyst comprises a first catalyst layer made of CuO or ZnO, the first catalyst layer reforming a gasified fuel into a hydrogen gas at the evaporating part.

5. The reformer according to claim 4, wherein the catalyst layer further comprises a second catalyst made of Al or Al₂O₃ provided underneath the first catalyst as a supporting layer for the first catalyst to maintain a stable catalyst function.

6. The reformer according to claim 5, wherein the second catalyst is formed on a surface of the flow path of the reforming part of the base and the first catalyst is formed on the second catalyst layer.

7. The reformer according to claim 1, wherein the first porous part formed in the evaporating part of the base comprises nano-pores integrally formed in the base by anode corrosion.

8. The reformer according to claim 1, further comprising a second porous part formed underneath the reforming part to increase a catalyst area.

9. The reformer according to claim 8, wherein the second porous part comprises nano-pores integrally formed in the base by anode corrosion.

10. The reformer according to claim 7, wherein the first porous part has insulation layers formed underneath with the heater disposed between the insulation layers.

11. The reformer according to claim 8, wherein the second porous part has insulation layers formed underneath with the heater disposed between the insulation layers.

12. The reformer according to claim 1, further comprising a cover member covering upper and lower parts of the base, the cover member having a fuel inlet and a hydrogen outlet.

13. The reformer according to claim 12, further comprising a means for removing CO to emit a high-purity hydrogen gas, the CO removing means formed on a portion of an inner surface of the cover member, corresponding to the position of an emission path at which a reformed hydrogen is emitted.

14. The reformer according to claim 13, wherein the CO removing means is made of one selected from Pt and Pd.
